(19) United States
(12) Patent Application Publication
(10) Pub. No.: US 2007/0239585 A1
(43) Pub. Date: Oct. 11, 2007

(54) Transaction Strategy

(76) Inventor: Keith G. Nielsen, Kenmore (AU)

Correspondence Address: EDWARDS ANGELL PALMER & DODGE LLP, P.O. BOX 55874, BOSTON, MA, 02205, US

(21) Appl. No.: 11/597,819

(22) PCT Filed: Jun. 1, 2005
(86) PCT No.: PCT/AU05/00769

§ 371 Date: Mar. 16, 2007

Related U.S. Application Data
(60) Provisional application No. 60/576,540, filed on Jun. 2, 2004.

(30) Foreign Application Priority Data
Jun. 2, 2004 (AU) 2004902962

(51) Int. Cl. G06F 19/00

(52) U.S. Cl. 705/36 R

(57) ABSTRACT

A method of determining a transaction strategy using a processing system. The method includes, for a respective stock, determining a demand data representing a demand level (110), and supply data representing a supply level (100). The demand and supply data are used to determine a buying pressure indicator (120) using the demand and supply data and generate a representation of variations in the buying pressure indicator over a predetermined time period, the representation being used to determine transaction strategy (130).

### BACKGROUND OF THE INVENTION

The present invention relates to a method and apparatus for determining a transaction strategy, and in particular to determine stock transactions based on levels of supply and demand.

### DESCRIPTION OF THE PRIOR ART

The reference to any prior art in this specification is not, and should not be taken as, an acknowledgment or any form of suggestion that the prior art forms part of the common general knowledge.

The concepts of supply and demand determining the price of goods or commodities in a free market is well known and understood. In its simplest terms the more demand there is the higher the price will be and vice versa. Furthermore it is known to utilise current supply and demand numbers for stocks in deciding whether stocks should be bought and sold. However, it is difficult to monitor the supply and demand for stock manually.

### SUMMARY OF THE PRESENT INVENTION

In a first broad form the present invention provides a method of determining a transaction strategy, the method including, in a processing system and for a respective stock:
a) determining demand data representing a demand level;
b) determining supply data representing a supply level;
c) determining a buying pressure indicator using the demand and supply data; and,
d) generating a representation of variations in the buying pressure indicator over a predetermined time period, the representation being used to determine transaction strategy.

Typically:
a) the demand level is indicative of at least one of:
   i) the number of buyers; and,
   ii) the number of shares wanted; and,
b) the supply level is indicative of at least one of:
   i) the number of sellers; and,
   ii) the number of shares offered.

Typically the method includes, in the processing system, receiving the demand and supply data from a remote processing system via a communications network.

Typically the representation includes a graph showing the buying pressure indicator against time.

Typically the method of determining the buying pressure indicator includes:
a) determining, using the supply data, sell price offers;
b) modifying the supply levels in accordance with the sell price offers;
c) determining, using the demand data, bid price offers;
d) modifying the supply levels in accordance with the bid price offers; and,
e) calculating the buying indicator using the modified supply and demand levels.

Typically the method includes:
a) comparing each sell price offer to a predetermined threshold based on the current share price;
b) ignoring the respective supply level for sell price offers falling outside the predetermined threshold;
c) comparing each bid price offer to a predetermined threshold based on the current share price;
d) ignoring the respective demand level for bid price offers falling outside the predetermined threshold.

Typically the method includes:
a) for each sell price offer:
   i) determine a respective weighting for the sell price offer;
   ii) determine the supply level;
   iii) modify the supply level using the respective weighting; and,
b) for each bid price offer:
   i) determine a respective weighting for the bid price offer;
   ii) determine the demand level;
   iii) modify the demand level using the respective weighting.

Typically the method includes determining the respective weighting in accordance with a current stock price.

Typically the method includes determining the respective weighting in accordance with the difference between the current sell price offer and at least one of the respective bid price offer and sell price.

Typically the buying pressure indicator is formed from at least one of:
a) the ratio of the number of buyers to the number of sellers; and,
b) the ratio of the number of shares wanted to the number of shares offered.

Typically the method includes, in the processing system:
a) comparing the buying pressure indicator to predetermined criteria; and,
b) determining the transaction strategy using the results of the comparison.

Typically the predetermined criteria include at least one of:
a) a predetermined buying pressure indicator;
b) a predetermined change of the buying pressure indicator; and,
c) a predetermined rate of change of the buying pressure indicator.

Typically the transaction strategy can include at least one of:
a) buying stock; and,
b) selling stock.

In a second broad form the present invention provides a method of determining a transaction strategy, the method including, in a processing system and for a respective stock:
a) determining a demand level;
b) determining a supply level;
c) determining a buying pressure indicator using the demand and supply levels; and,
d) generating a representation of variations in the buying pressure indicator over a predetermined time period, the representation being used to determine transaction strategy.

In a third broad form the present invention provides a method of determining a transaction strategy, the method including, in a processing system, and for a respective stock:
a) determining demand data representing a demand level;
b) determining supply data representing a supply level;
c) determining a buying pressure indicator using the demand and supply data;
d) comparing the buying pressure indicator to predetermined criteria; and,
e) generating a notification used to determine the transaction strategy using the results of the comparison.

Typically the method includes generating a representation of variations in the buying pressure indicator over a predetermined time period, the representation being used to determine transaction strategy.

In a fourth broad form the present invention provides a method of determining a transaction strategy, the method including, in a processing system:
a) for each of a number of stocks;
   i) determining demand data representing a demand level;
   ii) determining supply data representing a supply level; and,
   iii) determining a buying pressure indicator using the demand and supply data;
b) comparing each buying pressure indicator to respective predetermined criteria; and,
c) generating a notification used to determine the transaction strategy using the results of the comparison.

Typically the method includes generating a representation of variations in the buying pressure indicator over a predetermined time period, the representation being used to determine transaction strategy.

The method of any broad form of the invention may be performed in accordance with the method of any other broad form of the invention.

### BRIEF DESCRIPTION OF THE DRAWINGS

An example of the present invention will now be described with reference to the accompanying drawings, in which:-

FIG. 1 is a flow chart outlining a method of determining a transactions strategy for stock trading;

FIG. 2 is a schematic diagram of a processing system for use in determining a transaction strategy;

FIG. 3 is a flow chart of a process of performing longitudinal analysis of a stock;

FIG. 4 is a schematic diagram of a representation generated by the processing system of FIG. 2;

FIG. 5 is a flow chart of a process of performing global analysis of a stock; and,

FIG. 6 is a schematic diagram of a network based system for determining a transaction strategy.

### DETAILED DESCRIPTION OF THE PREFERRED EMBODIMENTS

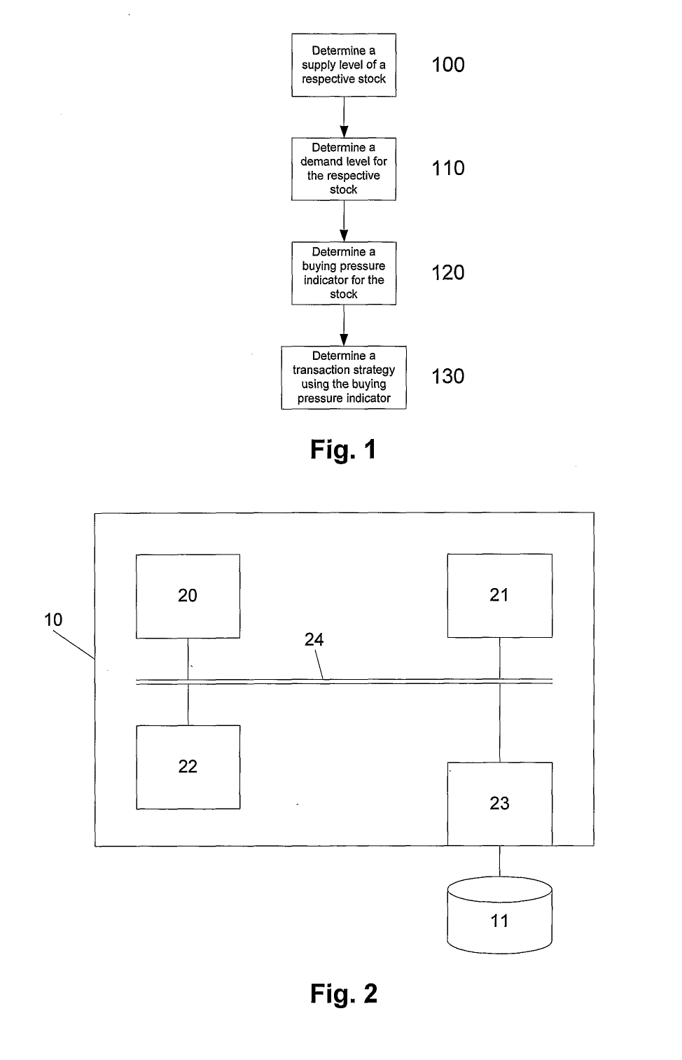

An example of a process for monitoring stocks, and using this to determine transaction strategies, will now be described with reference to FIG. 1.

In particular, as shown in FIG. 1 the process generally includes at step 100 determining a supply level, at step 110 determining a demand level and at step 120 using this to determine a buyer pressure indicator. As will be described in more detail below, the buyer pressure indicator may be determined in a number of ways, but in one example is a ratio of the number of shares wanted to the number of shares offered, and in a second example, is a ratio of the number of buyers to the number of sellers.

Once the buying pressure indicator is determined, at step 130 the process involves determining a transaction strategy, such as buying or selling stock, in accordance with the determined buyer pressure indicator.

In general, this process is performed by a processing system, thereby allowing the process to be substantially automated. An example of a suitable processing system is shown in FIG. 2. In this example, the processing system 10 includes a processor 20, a memory 21, an input/output (I/O device) 22, such as a display and keyboard, and an external interface 23 coupled together via a bus 24. In use, the external interface 23 allows the processing system to be coupled to other processing systems, via a communications network or the like, as will be described in more detail below, or to an external database 11, as shown.

In use, the processing system 10 is adapted to determine the supply and demand levels from appropriate input data received either via the external interface 23, or the I/O device 22. The processing system 10 can then automatically determine the buyer pressure indicator and provide an indication of this to a user in a manner which allows the user to determine a transaction strategy.

It will therefore be appreciated that the processing system may be formed from any form of processing system which is capable of receiving data, performing appropriate calculation, and providing an output notification. Accordingly, it will be appreciated that the processing system may be any form of processing system suitably programmed to perform the content presentation and/or modification, as will be described in more detail below. The processing system may therefore be a suitably programmed computer, lap-top, palm computer, PDA, server, suitable programmed mobile phone, or the like. Alternatively, specialised hardware or the like may be used.

In general, the analysis of the buyer pressure indicator can be performed in a number of different ways depending on the circumstances in which it is used. For example, analysis can be performed by monitoring the buyer pressure indicator for a respective stock over a predetermined time period (hereinafter referred to as “longitudinal analysis”) or by analysing a larger number of stocks at a given time period (hereinafter referred to as “a global analysis”).

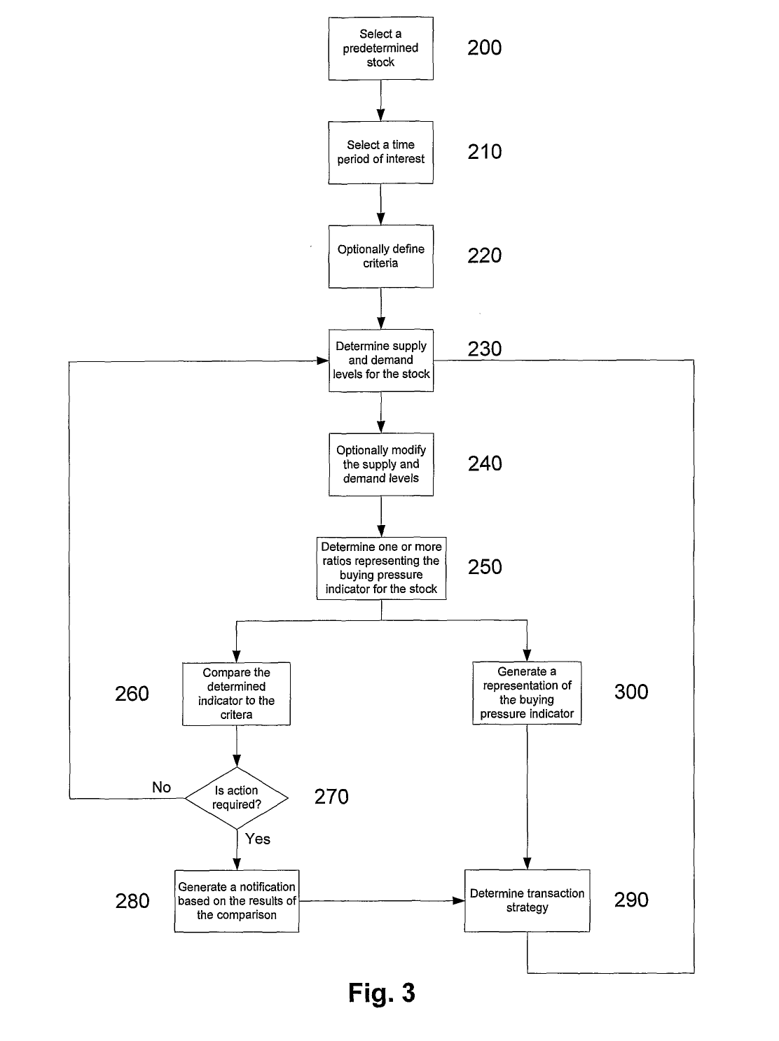

An example of the process for longitudinal analysis will now be described with reference to FIG. 3. For the purpose of this example, it is assumed that the processing system 10 is executing applications software which causes the processing system 10 to generate a graphical user interface (GUI) on the display. This allows the user to interact with the processing system using the I/O device 22 and thereby allowing the processing system 10 to perform the process set out in FIG. 3.

At step 200 the user selects a particular stock of interest. This will typically be achieved by selecting either a predetermined stock from a dropdown list, or by providing an indication of the stock via the I/O device 22. At step 210 the user selects a time period of interest in a similar manner. At step 220 the user optionally specifies predetermined criteria which are used in generating notifications as will be described below.

At step 230 the processing system 10 operates to determine the supply and demand levels for the selected stock over the selected time period. In this regard, the supply and demand levels will typically be undergoing constant variation throughout the time period as stock is purchased and sold. As it is, changes in the relative supply and demand levels, as well as the instantaneous levels that are of interest, in one example this is achieved by obtaining an indication of the supply and demand levels at discrete times over the time period. This allows the buying pressure indicator to be determined at the respective discrete times and, hence, for changes in the buying pressure indicator to be determined as will be described in more detail below.

The provision of the supply and demand level data may be achieved in any one of a number of ways such as asking the user to supply the data, or automatically accessing predetermined data stored in the database 11, or obtaining the data from a remote processing system via a network. Thus for example, this could involve downloading the data from a suitable source via the Internet.

It will be appreciated by persons skilled in the art that the frequency with which the demand and supply levels are determined will depend on a number of factors, such as the availability of the data from the stock market, the computational power of the processing system, and hence how frequently the buying pressure indicator can be calculated, which can be a factor particularly if a large number of stocks are being monitored simultaneously.

At step 240 the processing system 10 operates to perform optional modification of the demand and supply levels. This is performed in order to avoid to outlier demand and supply levels from unduly influencing the determined buyer pressure indicator.

In particular, buyers and sellers will generally propose prices for the transaction of the respective stock. Thus a buyer will provide an indication of a price at which stock is to be purchased whereas a seller will indicate a sale price. It will be appreciated by a person skilled in the art that the value of these may differ substantially to the current stock price and therefore represent an unrealistic transaction. Accordingly, as such transactions are unlikely to occur it is preferable that they have reduced impact on the buyer pressure indicator.

This can be achieved in a number of manners. For example, any offers for sale, or requests for purchase for which the proposed transaction value differs from the current stock value by more than a predetermined amount can be discounted. This process, which can be referred to as truncating, means that only proposed transactions whose price falls within a predetermined threshold range of the current stock value should be taken into account.

Alternatively, the determined supply and demand levels can be weighted so as to alter the impact of transactions based on the difference between the proposed demand and supply values and the current share price. The manner in which the weighting is performed can vary depending on the implementation, but in one example, this is achieved by determining the difference between the proposed transaction price and the current stock price, and using this to generate a weighting which is then applied to the demand or supply levels.

At step 250, the processing system 10 then determines a buyer pressure indicator by generating a ratio of the demand level to the supply level. This is achieved using the modified versions of the demand and supply levels if these are provided.

In one example, the buying pressure indicator can be a simple ratio based on the number of shares wanted and the number of shares offered. Alternatively however, it is also possible to determine a ratio taking into account the number of buyers and sellers.

An example of this will now be described with respect to table 1 below, which sets out the data determined by the processing system 10 for one example, at one respective time instance.

TABLE 1

| | # Buyers | QTY | BID | # Sellers | QTY | ASK |
|---|---|---|---|---|---|---|
| | 1 | 10000 | $1.00 | 1 | 2000 | $1.01 |
| | 2 | 5000 | 0.99 | 1 | 5000 | $1.02 |
| | 5 | 10000 | 0.98 | 2 | 1000 | $1.03 |
| | 4 | 2000 | 0.97 | 1 | 2000 | $1.04 |
| TOTALS | 12 | 27000 | | 5 | 10000 | |

In the above example, the current share price is $1.00, and any transactions that differ from the current share price by more than $0.05 are ignored. Accordingly, in this case, the data in table 1 above represents truncated supply and demand levels.

In any event, in this example, the buying pressure indicator includes two ratios, namely a buying pressure ratio and a position pressure ratio. These are determined as follows:

$$\begin{matrix}Buying pressure ratio = £ shares on the buy side \text{/} \\ = £ of shares on the sell side \\ = 27000 \text{/} 10000 \\ = 2.7 \\ Position pressure ratio = £ of buyers \text{/} £ of sellers \\ = 12 \text{/} 5 \\ = 2.4\end{matrix}$$

At step 260 the processing system 10 compares the determined buyer pressure indicator to the predetermined criteria defined at step 220.

The predetermined criteria represent thresholds to which the processing system 10 compares the buyer pressure indicator. The thresholds will be based on different parameters depending on the user inputs that may include for example:
absolute buyer pressure indicator values;
relative buyer pressure indicator values;
differences between the buyer pressure indicator ratios;
rate of change of the buyer pressure indicator over a predetermined time period minimum/maximum numbers of shares on offer
absolute price thresholds
recent changes in share price

Depending on the results of the comparison, further action may be required. If the processing system 10 determines no further action is required at step 270, the process returns to step 230 to determine the latest demand and supply levels, and thereby repeat the process. If a threshold is exceeded (or fallen below), the processing system 10 determines action is required at step 270.

Thus, for example, if the comparison determines that there has been a recent increase in the buyer pressure indicator, this is indicative of an increase in the demand for the stock, which should cause a corresponding increase in share price. Accordingly, the processing system 10 may perform a further comparison, to determine if the expected share price increase has yet occurred. If not, this indicates that it is a good time to buy the shares as an increases in share price is to be expected in the near future.

Alternatively, if the share price has increased, then this may indicate that any expected increase has already occurred, and unless the buying pressure indicator is maintained at a high level, there is no longer the incentive to buy shares in the respective stock.

It will therefore be appreciated by persons skilled in the art that the comparison performed may be a multi-stage comparison, in which the results of a first comparison trigger the processing system to perform further comparisons.

Once the action has been determined and optionally performed, the processing system may determine that a notification is to be provided to the user at step 280. The notification will indicate to the user which threshold comparison has returned a positive result allowing the user to select an appropriate transaction strategy, such as buying or selling stock at step 290.

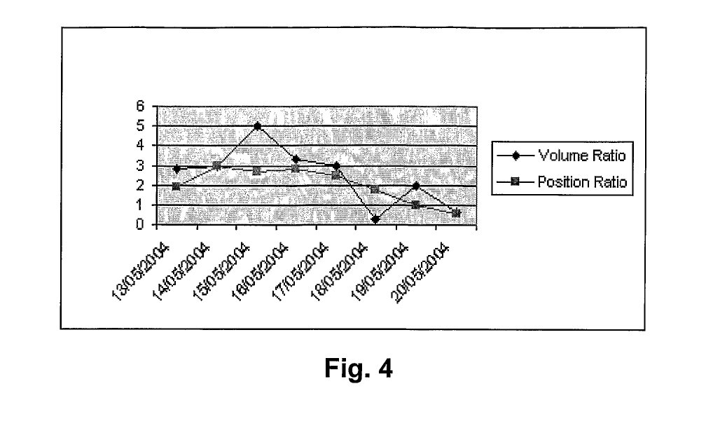

As an alternative, or an additional mode of operation, once the buyer pressure indicator has been determined at step 250 the process can move on to step 300 to generate a representation of the variation of the buyer pressure indicator over time. This is typically done in a graphical form an example of which is shown in FIG. 4.

In this instance the graphical representation of the buyer pressure indicator, which in this example, shows both the buyer pressure and position pressure ratios, assists the user is assessing whether a particular transaction strategy should be used.

In this example, the ratios are calculated once a day. Typically however the buying pressure indicator would be determined more regularly, such as once an hour, depending on the level of information required by the user, the availability of supply and demand level data and the like. Alternatively the buying pressure indicator could be generated substantially in real time, such as by updating the indicator every few seconds.

The rate of calculation may also be altered based on the results of the comparison. Thus, for example, if the comparison indicates that there has been a change in the buyer pressure indicator of more than a predetermined amount in a given time period, this may be indicative of the fact that a potentially major change in stock transaction behaviour is imminent. Accordingly, if this occurs, the processing system 10 can be adapted to monitor the buying pressure index for the respective stock more frequently. The process can then return to step 230 as shown to determine further buyer and seller numbers. Thus, this process can be performed constantly by the processing system 10 to allow monitoring to be performed over long time periods, such as days, weeks, months or the like.

The process may be performed in the background of an operating system with a notification being generated as required in the form of a pop-up dialogue box or the like. In addition to this, or as an alternative, the processing system 10 can provide a window including the generated representation which is updated as required such that the user is constantly presented with the representation of the latest time period. Thus the user may for example set the processing system up such that the generated representation shows the variations in buyer pressure indicator for the most recent 24 hours, or the like.

As mentioned above in addition to performing a longitudinal analysis it is also possible to perform global analysis in which a number of different stocks are measured simultaneously.

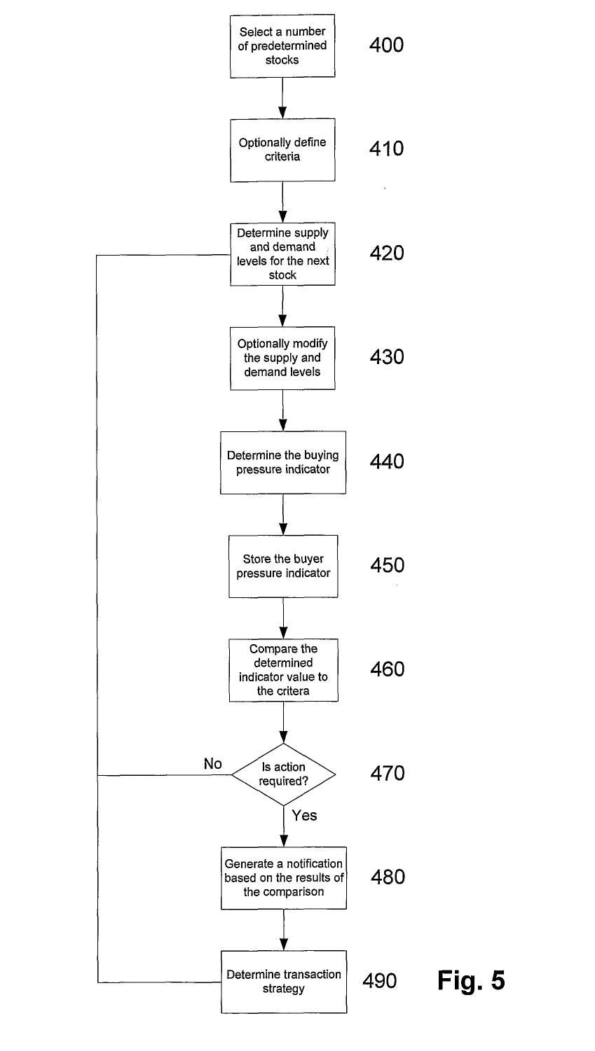

It will be appreciated that this process is substantially similar to that described above but will in any event be described in more detail with respect to FIG. 5. At step 400 the user selects a number of stocks. Again this may be achieved using a drop-down list on the GUI and it is possible to have groups of pre-selected stocks, which can be monitored. These may consist of groups of related stocks such as stocks for banks or the like.

At step 410 corresponding predetermined criteria are selected. It will be appreciated by a person skilled in the art that this may be performed automatically by the processing system 10 based on the selected stock, or alternatively may be performed by having the user input appropriate criteria values using the GUI.

At step 420 the processing system determines, for the next indicated stock, the corresponding demand and supply levels.

At step 430 the demand and supply levels are optionally weighted before a buying pressure indicator is determined at step 440. An indication of the indicator value is then stored in the database or memory 21 at step 450, before being compared to the predetermined criteria at step 460.

At step 470 the processing system 10 determines if action is required, based on the results of the comparison, if not returns to step 420 to determine the demand and supply levels for the next stock. Otherwise at step 480 a notification is generated and a transaction strategy selected accordingly at step 490, before returning to step 420 to determine the demand and supply levels for the next stock.

The comparison performed at step 470 may be performed in any one of a number of ways. Thus, for example, the predetermined criteria may be based solely on absolute values, representing for example rates of change of buyer pressure indicator or the like. Alternatively, in this example the predetermined criteria may apply to the buyer pressure indicator value determined for the group of stock collectively.

Thus, the processing system 10 may operate to rank the stocks in the group, with the order being determined using the relative buyer pressure indicator, with stocks having a higher buyer pressure indicator being preferentially purchased and stocks having a lower buyer pressure indicator being preferentially sold. This may be used for example to rate which stocks within a portfolio should be purchased or sold.

As far as the selection of the transaction strategy is concerned, this may be performed manually by an operator for example based on experience. This is therefore a very subjective approach with the assessment of the strategy being left to the operator themselves.

Alternatively, the strategy may be selected or at least suggested automatically by the processing system 10. This can be performed automatically in accordance with the results of the comparison and the subsequently generated notification. In this instance the notification may therefore also indicate to the user the proposed strategy.

For example, if a respective stock has a buyer pressure indicator threshold set to the value “3”, if this value is exceeded, this may indicate that the processing system 10 that stock is to be purchased, thereby generating appropriate notification to the user. Similarly, if the buyer pressure indicator falls below a threshold “1” this indicates that stock is to be sold.

Alternatively, the threshold may represent a predetermined rate of change of the buyer pressure indicator in which case the processing system 10 must be adapted to compare the current buyer pressure indicator to previous buyer pressure indicators thereby representing a form of limited longitudinal analysis.

In this particular process it will be appreciated that longitudinally analysis may be performed simultaneously on a number of different stocks, which represents a combination of the processes described above with respect to FIGS. 3 and 5.

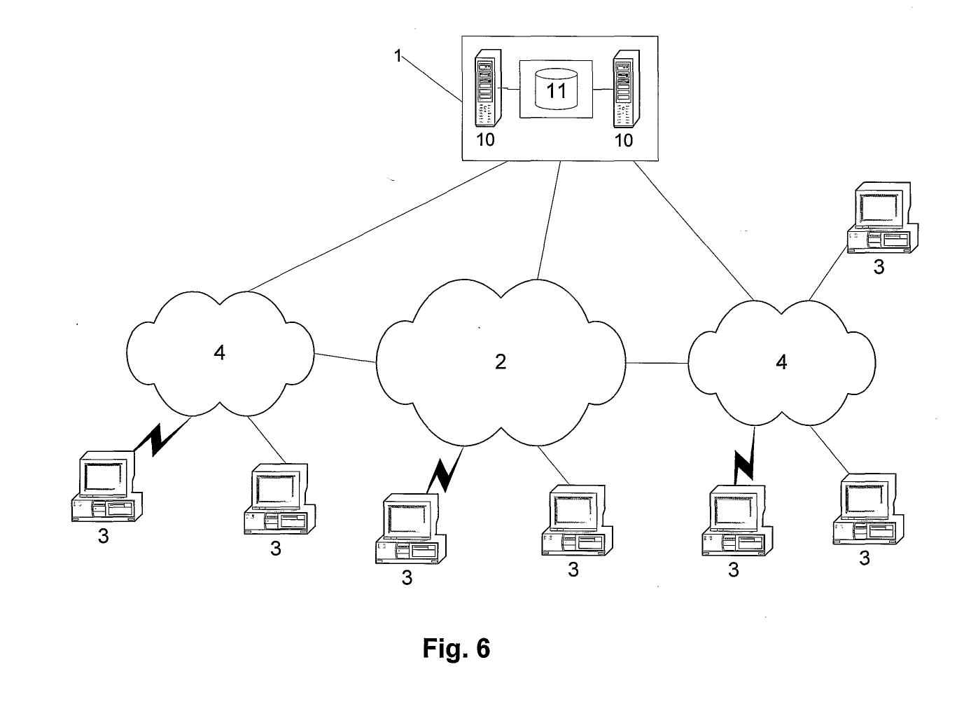

This process can be used to continually monitor the buying pressure indicator for all available stocks on a respective stockmarket, such as the ASX, with the buying pressure indicator being stored in a database for later retrieval and review. This allows users to mine the database and monitor past trends of buying pressure indicators to determine, or update the predetermined criteria, as well as to assist in determining transaction strategies. It will be appreciated by a person skilled in the art that this form of system may typically be provided in a network environment such as that shown in FIG. 6. In particular, as shown in FIG. 6 architecture includes a base station 1 having the processing system 10 coupled to a database 11. The base station 1 is coupled to a number of end stations 3 via the communications networks 2, 4.

In one example, the communications networks 2 represent internal networks within an organisation, such as a LAN (Local Area Network), with the communications network 4 being an external network such as the Internet. The communications networks 2, 4 may be any form of a network depending on the implementation and may be therefore be wired or wireless networks such as the GSM mobile phone network.

In this example, the end stations may be any form of a processing system as appropriate to the specific architecture, and may therefore be similar in form and function to the processing system 10.

It will therefore be appreciated by a person skilled in the art that the end stations 3, or the base station 1, communicate with each other and thereby provide the functionality described above. This can be performed in a number of manners such that the steps in the flow charts above can be performed be any one or more of the end stations 3 and the base station 1, either separately, or acting in conjunction.

Thus, for example, the end stations 3 may be adapted to obtain the buyer and seller numbers via the LANs 2 or the Internet 4 from the base station 1. Determination of the buyer pressure indicators and the selection of associated strategies can then be performed locally with the results being provided to a user of one of the end stations 3. Thus for example, an organisation may include an end station 3 which determines the buyer pressure indicators in accordance with the methodologies of FIGS. 3 or 5 and provide the results of this to users of the end stations 3. Alternatively each end station 3 can perform the task itself.

Alternatively, the buyer pressure indicators can be determined at the base station 1 using the associated processing system 10 with the results being transferred to the end stations 3.

In any event, it will be appreciated that this allows organisations to provide buyer pressure indicators to analysts or the like.

Persons skilled in the art will appreciate that numerous variations and modifications will become apparent. All such variations and modifications which become apparent to persons skilled in the art, should be considered to fall within the spirit and scope that the invention broadly appearing before described.

1. A method of determining a transaction strategy, the method including, in a processing system and for a respective stock:
a) determining demand data representing a demand level;
b) determining supply data representing a supply level;
c) determining a buying pressure indicator using the demand and supply data,
wherein the buying pressure indicator is based on at least one of a difference and a comparison between:
1) a ratio of the number of buyers to the number of sellers; and,
2) a ratio of the number of shares wanted to the number of shares offered; and,
d) generating a representation of variations in the buying pressure indicator over a predetermined time period, the representation being used to determine transaction strategy.

2. A method according to claim 1, wherein the method includes, in the processing system, receiving the demand and supply data from a remote processing system via a communications network.

3. A method according to claim 1, wherein the representation includes a graph showing the buying pressure indicator against time.

4. A method according to claim 1, wherein the method of determining the buying pressure indicator includes:
a) determining, using the supply data, sell price offers;
b) modifying the supply levels in accordance with the sell price offers;
c) determining, using the demand data, bid price offers;
d) modifying the supply levels in accordance with the bid price offers; and,
e) calculating the buying indicator using the modified supply and demand levels.

5. A method according to claim 4, wherein the method includes:
a) comparing each sell price offer to a predetermined threshold based on the current share price;
b) ignoring the respective supply level for sell price offers falling outside the predetermined threshold;
c) comparing each bid price offer to a predetermined threshold based on the current share price;
d) ignoring the respective demand level for bid price offers falling outside the predetermined threshold.

6. A method according to claim 4, wherein the method includes:
a) for each sell price offer:
i) determine a respective weighting for the sell price offer;
ii) determine the supply level;
iii) modify the supply level using the respective weighting; and,
b) for each bid price offer:
i) determine a respective weighting for the bid price offer;
ii) determine the demand level;
iii) modify the demand level using the respective weighting.

7. A method according to claim 6, wherein the method includes determining the respective weighting in accordance with a current stock price.

8. A method according to claim 7, wherein the method includes determining the respective weighting in accordance with the difference between the current sell price offer and at least one of the respective bid price offer and sell price.

9. A method according to claim 1, wherein the method includes, in the processing system:
a) comparing the buying pressure indicator to predetermined criteria; and,
b) determining the transaction strategy using the results of the comparison.

10. A method according to claim 9, wherein the predetermined criteria include at least one of:
a) a predetermined buying pressure indicator;
b) a predetermined change of the buying pressure indicator; and,
c) a predetermined rate of change of the buying pressure indicator.

11. A method according to claim 1, wherein the transaction strategy can include at least one of:
a) buying stock; and,
b) selling stock.

12. A method of determining a transaction strategy, the method including, in a processing system and for a respective stock:
a) determining a demand level;
b) determining a supply level;
c) determining a buying pressure indicator using the demand and supply levels, wherein the buying pressure indicator is based on at least one of a difference and a comparison between:
1) a ratio of the number of buyers to the number of sellers; and,
2) a ratio of the number of shares wanted to the number of shares offered; and,
d) generating a representation of variations in the buying pressure indicator over a predetermined time period, the representation being used to determine transaction strategy.

13. (canceled)

14. A method of determining a transaction strategy, the method including, in a processing system and for a respective stock:
a) determining demand data representing a demand level;
b) determining supply data representing a supply level;
c) determining a buying pressure indicator using the demand and supply data,
wherein the buying pressure indicator is based on at least one of a difference and a comparison between:
1) a ratio of the number of buyers to the number of sellers; and,
2) a ratio of the number of shares wanted to the number of shares offered; and,
d) comparing the buying pressure indicator to predetermined criteria; and,
e) generating a notification used to determine the transaction strategy using the results of the comparison.

15. A method according to claim 14, wherein the method includes generating a representation of variations in the buying pressure indicator over a predetermined time period, the representation being used to determine transaction strategy.

16. (canceled)

17. A method of determining a transaction strategy, the method including, in a processing system:
a) for each of a number of stocks;
i) determining demand data representing a demand level;
ii) determining supply data representing a supply level; and,
iii) determining a buying pressure indicator using the demand and supply data, wherein the buying pressure indicator is based on at least one of a difference and a comparison between:
1) a ratio of the number of buyers to the number of sellers; and,
2) a ratio of the number of shares wanted to the number of shares offered; and,
b) comparing each buying pressure indicator to respective predetermined criteria; and,
c) generating a notification used to determine the transaction strategy using the results of the comparison.

18. A method according to claim 17, wherein the method includes generating a representation of variations in the buying pressure indicator over a predetermined time period, the representation being used to determine transaction strategy.

19. (canceled)

20. A method of determining a transaction strategy, the method including, in a processing system and for a respective stock:
a) determining demand data representing a demand level;
b) determining supply data representing a supply level;
c) determining a buying pressure indicator using the demand and supply data,
wherein the buying pressure indicator is formed from at least one of:
1) a ratio of the number of buyers to the number of sellers; and,
2) a ratio of the number of shares wanted to the number of shares offered; and,
d) generating a representation of variations in the buying pressure indicator over a predetermined time period, the representation being used to determine transaction strategy.

21. A method of determining a transaction strategy, the method including, in a processing system and for a respective stock:
a) determining a demand level;
b) determining a supply level;
c) determining a buying pressure indicator using the demand and supply levels,
wherein the buying pressure indicator is formed from at least one of:
1) a ratio of the number of buyers to the number of sellers; and,
2) a ratio of the number of shares wanted to the number of shares offered; and,
d) generating a representation of variations in the buying pressure indicator over a predetermined time period, the representation being used to determine transaction strategy.

22. A method of determining a transaction strategy, the method including, in a processing system and for a respective stock:
a) determining demand data representing a demand level;
b) determining supply data representing a supply level;
c) determining a buying pressure indicator using the demand and supply data,
wherein the buying pressure indicator is formed from at least one of:
1) a ratio of the number of buyers to the number of sellers; and,
2) a ratio of the number of shares wanted to the number of shares offered; and,
d) comparing the buying pressure indicator to predetermined criteria; and,
e) generating a notification used to determine the transaction strategy using the results of the comparison.

23. A method of determining a transaction strategy, the method including, in a processing system:
a) for each of a number of stocks;
i) determining demand data representing a demand level;
ii) determining supply data representing a supply level; and,
iii) determining a buying pressure indicator using the demand and supply data, wherein the buying pressure indicator is formed from at least one of:
1) a ratio of the number of buyers to the number of sellers; and,
2) a ratio of the number of shares wanted to the number of shares offered; and,
b) comparing each buying pressure indicator to respective predetermined criteria; and,
c) generating a notification used to determine the transaction strategy using the results of the comparison.
